(19) United States
(12) Patent Application Publication
(10) Pub. No.: US 2008/0226850 A1
(43) Pub. Date: Sep. 18, 2008

(54) Alternating Spacer Frame Line Control

(75) Inventors: Byron C. Clayton, Sagamore Hills, OH (US); Paul Dorsch, Warren, OH (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: GED Integrated Solutions, Inc., Twinsburg, OH (US)

(21) Appl. No.: 11/686,365

(22) Filed: Mar. 15, 2007

(51) Int. Cl. E06B 3/673; G06F 19/00

(52) U.S. Cl. 428/34; 700/117

(57) ABSTRACT

Each of the multiple spacer frame fabricating machines executes its portion of a schedule, then alerts an operator(s) he or she should move to another spacer frame machine that is simultaneously providing spacer frames for the same schedule. The multiple controllers running the multiple spacer machines continue to prompt the operator until the production schedule has been completed. By alternately choosing spacers from different machines, the operator(s) can maintain the proper spacer sequence on the overhead conveyor.

### FIELD OF THE INVENTION

The present invention concerns a control system for operation of multiple parallel spacer frame machines.

### BACKGROUND

GED Integrated Solutions, Inc. manufactures, sells and supports machines that fabricate spacers to be used in insulating glass units (Intercept machines). Intercept machines fabricate spacers from a variety of substrate materials including tin plated steel and stainless steel.

Intercept machines employ or utilize controllers that access electronic files (schedules), each of which specifies the length, configuration and sequence of a multitude number of spacer frames. As the intercept machine fabricates and ejects each spacer frame, an operator places the spacer frame on an overhead conveyor in the same sequence that it is fabricated. It is important to maintain the exact order of the spacer frames to synchronize with other components and machines later in the insulating glass unit fabrication process.

Each Intercept machine fabricates the spacers from one electronic file for output to one overhead conveyor. Although this is efficient, but on occasion, productivity can be increased by having multiple Intercept machines simultaneously fabricate one schedule for one overhead conveyor.

### SUMMARY OF THE INVENTION

The disclosure concerns a system that controls multiple spacer frame machines to simultaneously fabricate spacer frames from one schedule for output to one overhead conveyor. Each of the multiple spacer frame fabricating machines executes its portion of a schedule, then alerts an operator(s) he or she should move to another spacer frame machine that is simultaneously providing spacer frames for the same schedule.

The multiple controllers running the multiple spacer machines continue to prompt the operator until the production schedule has been completed. By alternately choosing spacers from different machines, the operator(s) can maintain the proper spacer sequence on the overhead conveyor. The control software can also direct the machines to fabricate different spacer configurations or substrates within a single schedule.

One specific exemplary embodiment of the invention includes one IGU line for making stainless steel spacers and a second IGU line that would make tin plated steel spacer frames. For an order or schedule having both types of spacer frames, it may be more effective to run the two machines in parallel rather than running all product of one type on one spacer frame fabricating machine, then suspend operation while setup occurs for the second type of frame on that same machine.

These and other objects and advantages of the disclosed system will become better understood from the accompanying detailed embodiment which is described in conjunction with the accompanying drawings.

### BRIEF DESCRIPTION OF THE DRAWINGS

FIG. 1 is a schematic depiction of a dual line insulating glass unit production facility; and

FIG. 2 is a flowchart of the steps used in alternating output from the dual line production facility of FIG. 1.

### EXEMPLARY MODE FOR PRACTICING THE INVENTION

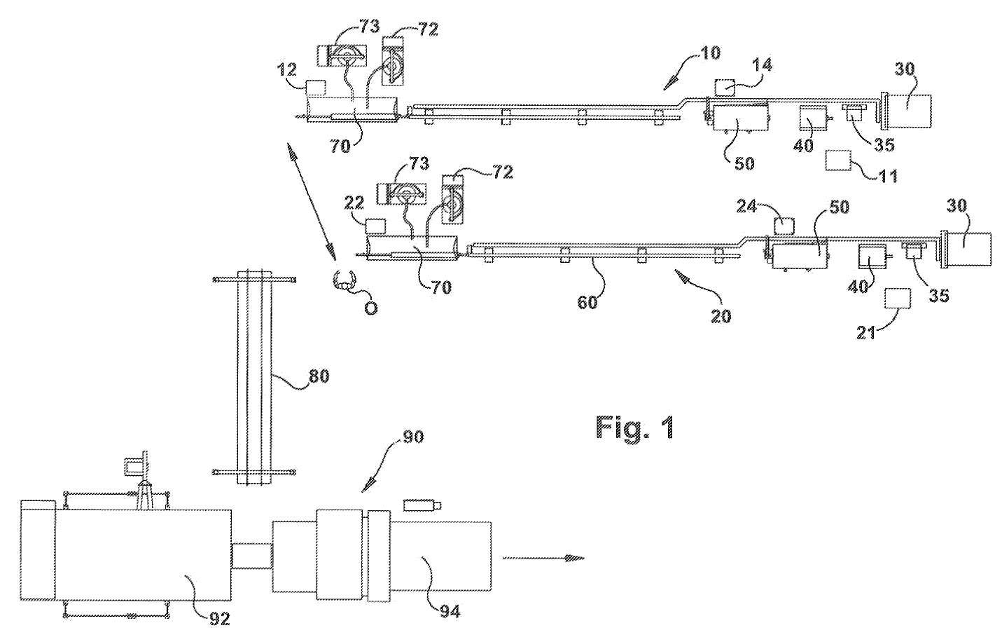

FIG. 1 depicts side by side insulating glass unit spacer frame fabrication machines 10, 20. A controller executes a stored program controls the operation of each line so that in a preferred embodiment the two lines have two controllers 14, 24 that are able to communicate with each by means of a network which passes data back and forth between controllers.

The controller dictates the unrolling of metal strip have a specified width from a source 30. Since in many regards the two machines are identical insofar as the components they include common reference characters will be used to designate in the drawings common components. Downstream from the source, the strip passes by a loop control 35 for the strip and through a punch 40 and a roll former 50 which produce a channel having side walls onto which adhesive is applied in a controlled amount.

The channel that exits the roll former 50 is carried by a conveyor 60 to a dessicant and adhesive applying station 70 where nozzles coupled to sources 72, 73 of dessicant and adhesive apply proper amounts of those materials to the frame. In the disclosed embodiment of the present invention one operator O can remove spacer frames from the appropriate machine and then bend the spacer frame into a closed form rectangular frame which is placed on an overhead conveyor 80 and conveyed to an assembly station 90. At the assembly stations cut to size lites exit a washer 92 and are combined with a spacer frame arriving on the conveyor and placed into an oven 94 for curing of the adhesive which holds the parts of the insulating glass unit thus assembled together.

As described in U.S. Pat. No. 5,313,761 to Leopold, the frame spaces apart two glass sheets or lites that are cut to an appropriate size and applied to opposite sides of the spacer frame. The contents of the '761 patent to Leopold are incorporated herein by reference.

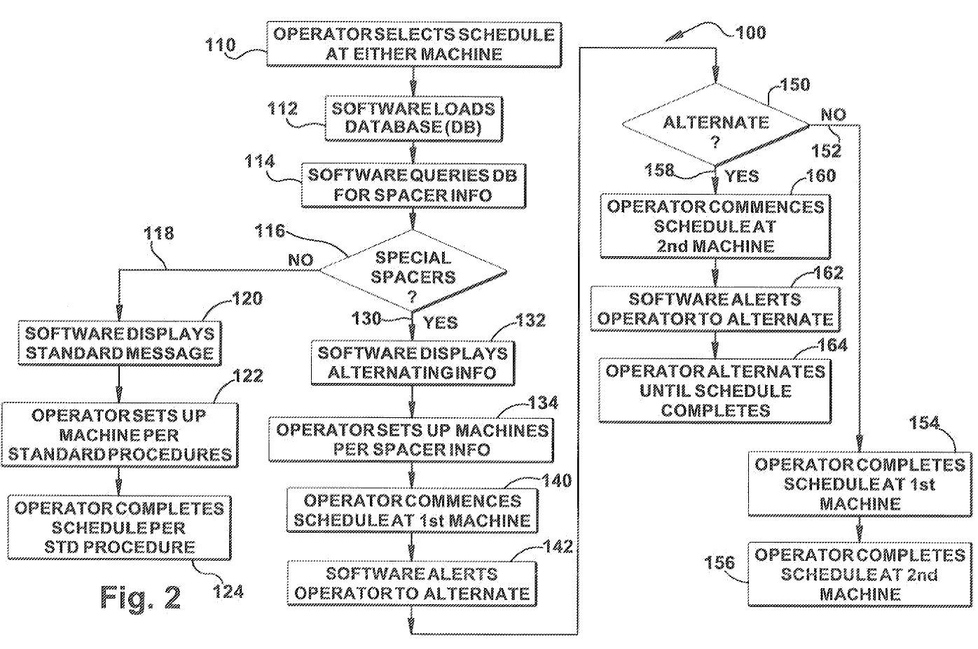

With alternating line software 100 depicted in the FIG. 2 flowchart executing on the two controllers, the operator O is prompted to select 110 the desired schedule to run on viewing monitors 11,21 that displays parameters for the two intercept machines 10, 20. The selection 110 by the operator of a schedule causes the controller to load 112 database information for that schedule from a database of information and query 114 the database for information regarding the spacer frames that make up the schedule. At a decision step 116, the controller determines if special spacers are part of the schedule. In the context of the present invention, this means the spacers from the two different machines 10, 20 are to be interleaved together on the conveyor 80. Assume the decision step 116 for a controller takes the no branch 118 meaning the controller is to fulfill the spacer frame requirements of the schedule from only one machine. The controller for that machine displays 120 a standard message to the operator prompting machine set up 122 following standard procedures followed by operation of the machine until the production schedule has been completed 124.

If on the other hand, a positive branch 130 is taken at the decision step 116, the operator O commences fabrication at one of the two intercept machines as indicated by the alternating line software running on the controllers. Since two (or possibly more) intercept machines are involved, the operator is initially prompted 132 and instructed 134 on set up of the two machines based on the contents of the schedule.

Assume the schedule starts with a first spacer made by the intercept machine 10 depicted in FIG. 1. The viewing monitors 11,12 display 140 a first unmade spacer frame from the schedule. The operator O moves to an end of the machine where a monitor 12 is updated as spacer frames are made. The operator removes each spacer from the Intercept machine 10 and places it on the overhead conveyor 80 in the order specified by the alternating line software. After one or more spacer frames dictated by the schedule are made on the machine 10, the alternating line software 100 alerts 142 the operator O that the schedule suggests moving to the other machine 20 to continue production.

The operator can either follow the suggestion or override the suggestion with a manual override. At a decision step 150 the operator either decides to change machines or to override the suggestion. Assume a no branch 152 is taken and the operator chooses not to switch to the machine 20. This occurs for example if the operator decides to complete all of the requirements of the schedule on the machine 10 and then switches to the machine 20. If the ‘no’ branch is followed, the operator continues to produce 154 spacer frames from the machine 10. Once all scheduled frames are made the operator will switch to the second machine 20 to make the frames in accordance with the scheduled frames on this second machine.

If however, the ‘yes’ branch 158 is taken, the operator has decided to following the prompt and move to the other intercept machine 20 to continue the schedule in the already optimized sequence.

The operator moves to the intercept machine 20 and commences 160 fabricating from the next spacer displayed by the Alternating Line Software. The operator will remove each spacer from the intercept machine 20 and place on the overhead conveyor 80 in the order specified by the Alternating Line Software. Via a computer monitor (2b), the Alternating Line Software will alert 162 the operator to move back to the intercept machine 10 to continue 164 the schedule and maintain the proper sequence. This process will continue until the schedule has been completed.

It is appreciated, that although an exemplary embodiment of the invention has been described with a degree of particularity, it is the intent that the invention include all modifications and alterations from the disclosed design falling within the spirit or scope of the appended claims.

1. A process for fulfilling a production schedule using two or more insulating glass unit fabricating machines in proximity to each other comprising:
a) allocating insulating glass unit (IGU) fabrication from the schedule to different fabricating machines chosen from the two or more insulating glass unit fabricating machines;
b) prompting a user to construct one or more consecutive IGUs on a first insulating glass unit fabricating machine;
c) prompting the user to switch to an alternate insulating glass unit fabricating machine to construct one or more additional consecutive IGUs on said alternate insulating glass unit fabricating machine; and
d) continuing to prompt the user to switch back and forth from the first and alternate machines until all IGUs in the production schedule have been constructed and interleaved in an appropriate way for downstream processing at a subsequent IGU processing station.

2. The process of claim 1 wherein each of the first and alternate insulating glass unit fabricating machines has a controller that executes software for prompting a user and further wherein prompts are shown on monitors associated with each of said machines.

3. The process of claim 2 comprising overriding the prompts and continuing to make spacer frames from the schedule in an order not deemed optimum by the control software.

4. Apparatus for fulfilling a production schedule using two or more insulating glass unit fabricating machines comprising:
a) a first insulating glass unit production machine for producing IGUs;
b) one or more additional insulating glass unit production machines for producing IGUs;
c) a controller for allocating insulating glass unit (IGU) fabrication from the schedule to different fabricating machines chosen from the two or more insulating glass unit fabricating machines comprising:
d) a monitor communicating with the controller for prompting a user to construct one or more consecutive IGUs on a first machine; and
e) a subsequent window or door processing station for performing other fabrication steps on IGUs produced by the first and one or more additional insulating glass unit production machines;
f) said controller prompting the user to switch to an alternate machine to construct one or more additional consecutive IGUs on an additional machine; and continuing to switch back and forth from the first and additional machine until all IGUs in the production schedule have been fulfilled.

5. The apparatus of claim 4 additionally comprising an override switch for continuing to make spacer frames on a machine even though the software executing on the controller prompts the user to switch machines.

6. The apparatus of claim 4 wherein there are as many controllers as there are IGU fabricating machines.

7. The apparatus of claim 6 wherein the controller monitor operation of the IGU fabricating machines and communications between controllers updates each controller on the progress in fulfilling a schedule by producing the IGUs that make up that schedule.

8. The process of claim 1 wherein the first insulating glass unit fabricating machine fabricates one of either stainless steel or tin plated steel spacer frames and the alternate insulating glass unit fabricating machine fabricates a different one of either stainless steel or tin plated steel spacer frames different form the first insulating glass unit fabricating machine.

9. The Apparatus of claim 4 wherein the first insulating glass unit production machine fabricates one of either stainless steel or tin plated steel spacer frames and the at least one of said one or more additional insulating glass unit production machines fabricates another one of either stainless steel or tin plated steel spacer frames different from the first insulating glass unit production machine.
